(19) United States
(12) Patent Application Publication
(10) Pub. No.: US 2017/0212852 A1
(43) Pub. Date: Jul. 27, 2017

(54) METHOD AND ACCELERATOR UNIT FOR INTERRUPT HANDLING

(71) Applicant: Samsung Electronics Co., Ltd., Gyeonggi-do (KR)

(72) Inventors: Balaji SOMU KANDASWAMY, Bangalore (IN); Patana Bhagwan REDDY, Bangalore (IN); Raju Siddappa UDAVA, Bangalore (IN); Tushar VRIND, Bangalore (IN); Venkata Raju INDUKURI, Bangalore (IN)

(73) Assignee: Samsung Electronics Co., Ltd.

(21) Appl. No.: 15/418,249

(22) Filed: Jan. 27, 2017

(30) Foreign Application Priority Data
Jan. 27, 2016 (IN) 201641002928

(51) Int. Cl. G06F 13/24; G06F 9/54

(52) U.S. Cl. CPC G06F 13/24; G06F 9/542

(57) ABSTRACT

An apparatus and method are provided for interrupt handling. A method includes receiving, by an accelerator unit, an interrupt request; stacking, by the accelerator unit, a plurality of general purpose registers in an inbuilt last in first out (LIFO) unit; and sending, by the accelerator unit, a vector address corresponding to the interrupt request to a processor, which processes the interrupt request.

### PRIORITY

This application claims priority under 35 U.S.C. §119(a) to an Indian Complete Patent Application Serial No. 201641002928, which was filed in the Indian Intellectual Property Office on Jan. 27, 2016, the entire content of which is incorporated herein by reference.

### BACKGROUND

1. Field of the Disclosure

The present disclosure relates generally to a data processing system, and more particularly, to a method and an accelerator unit for interrupt handling.

2. Description of the Related Art

Generally, a processor communicatively coupled to a data processing system carries interrupts from an interrupt controller. As interrupts can be generated in a plurality of devices, such as peripheral devices external to the processor, an interrupt control system is usually used for collecting external interrupt signals received from a plurality of interrupt sources and sending the external interrupt signals to the processor as interrupt request signals (IRQs). Examples of the data processing system may include an embedded system, a mobile device, a computer, etc.

An IRQ notifies the processor of an occurrence of an irregular and/or exceptional event. An interrupt is usually the result of an event occurring outside of a central processor, such as an event occurring in peripheral device or from an internal component, which requires the processor to pause current operations that are being executed and switch to an interrupt service routine (ISR), which may be stored in a memory. Generally, an ISR is specifically configured to handle the interrupt. Thereafter, the processor resumes a normal instruction routine.

Further, the interrupt controller may provide a vector address for each external interrupt signal. The interrupt controller may be associated with interrupt controller hardware, e.g., a vectored interrupt controller (VIC), a generic interrupt controller (GIC), etc., which are used to prioritize interrupts in order to provide the highest priority interrupt to the processor. Once the processor receives the vector address corresponding to the external interrupt signal from the VIC, the processor abandons a current execution routine and restarts multi-cycle instruction, such as load or store load multiple registers (LDM), PUSH, or POP, if an interrupt request received from the VIC is made part way through execution. The ISR can then be fetched from instruction cache, the memory, or a tightly-coupled memory (TCM), while the data cache lines fill up.

For example, in order for the ARM® Cortex®-R4 to respond to an interrupt takes 20 cycles using a dedicated fast interrupt request (FIQ), which is the best case and assumes an ISR is immediately available in the R4 TCM or cache. Worst case response increases to 30 cycles when using the IRQ.

Also, during post ISR scheduling, the time consumed by a scheduler decision procedure to identify highest ready task to be activated, and context restore for the preempted or relinquished task cause a delay to process the IRQ.

While there are some conventional methods that attempt to reduce interrupt latency by using nested interrupt handlers, which allow further interrupts to occur while currently servicing an interrupt routine, these conventional methods are only used in some systems, and there is not much evidence about any actual reduction in interrupt latency. Even an optimal real time operating system (RTOS) requires a minimal program code to store a return state (context) when a running task is interrupted.

Additionally, a faster interrupt response is always critical in any data processing system. Thus, there exists a need to reduce interrupt latency for a deterministic behavior of the data processing system.

### SUMMARY

An aspect of the present disclosure is to provide a method and an accelerator unit for interrupt handling.

Another aspect of the present disclosure is to provide a mechanism for receiving an interrupt request at an accelerator unit.

Another aspect of the present disclosure is to provide a mechanism through which an accelerator unit is utilized for stacking a general purpose register or a plurality of general purpose registers in an inbuilt last in first out (LIFO) unit.

Another aspect of the present disclosure is to provide a mechanism through which an accelerator unit can send a vector address corresponding to an interrupt request to a processor to process the interrupt request.

Another aspect of the present disclosure is to provide a mechanism for receiving an interrupt request by a processor, from an accelerator unit, and processing the interrupt request.

Another aspect of the present disclosure is to provide a mechanism for detecting, by a processor, a scheduler indication associated with an interrupt request.

Another aspect of the present disclosure is to provide a mechanism for performing, by a processor, an action based on scheduler indication post processing of an interrupt request.

In accordance with an aspect of the present disclosure a method is provided for interrupt handling. The method includes receiving, by an accelerator unit, an interrupt request; stacking, by the accelerator unit, a plurality of general purpose registers in an inbuilt last in first out (LIFO) unit; and sending, by the accelerator unit, a vector address corresponding to the interrupt request to a processor, which processes the interrupt request.

In accordance with another aspect of the present disclosure a method is provided for handling interrupt. The method includes receiving, by a processor from an accelerator unit, an interrupt request; processing, by the processor, the interrupt request; detecting, by the processor, a scheduler indication associated with the interrupt request; and performing, by the processor, an action based on the scheduler indication.

In accordance with another aspect of the present disclosure an interrupt controller is provided for interrupt handling including a processor; and an accelerator unit including an inbuilt last in first out (LIFO) unit. The accelerator unit is configured to receive an interrupt request, stack a plurality of general purpose registers in the inbuilt LIFO unit, and send a vector address corresponding to the interrupt request to the processor, which processes the interrupt request.

In accordance with another aspect of the present disclosure an accelerator unit is provided, which includes an inbuilt Last-in-First-Out (LIFO) unit for interrupt handling. The accelerator unit is configured to receive an interrupt request. Further, the accelerator unit is configured to stack a plurality of general purpose registers in the inbuilt LIFO unit. Furthermore, the accelerator unit is configured to send a vector address corresponding to the interrupt request to a processor to process the interrupt request.

In accordance with another aspect of the present disclosure accelerator unit is provided, which includes a master unit that receives an interrupt request; an inbuilt last in first out (LIFO) unit that stacks a plurality of general purpose registers in the inbuilt LIFO unit. The master unit is also configured to send the vector address corresponding to the interrupt request to a processor, which processes the interrupt request.

In accordance with another aspect of the present disclosure a processor is provided for handling an interrupt. The processor is configured to receive an interrupt request from an accelerator unit; process the interrupt request; detect a scheduler indication associated with the interrupt request; and perform an action based on the scheduler indication.

### BRIEF DESCRIPTION OF FIGURES

The above and other aspects, features, and advantages of certain embodiments of the present disclosure will be more apparent from the following detailed description taken in conjunction with the accompanying drawings, in which:

FIG. 1A illustrates a central processing unit (CPU) cycle delay during a conventional mechanism for interrupt handling;

FIG. 1B illustrates conventional post ISR scheduling latency;

FIG. 2A illustrates an interrupt controller and a processor unit for interrupt handling, according to an embodiment of the present disclosure;

FIG. 2B illustrates an accelerator unit associated with an interrupt controller for interrupt handling, according to an embodiment of the present disclosure;

FIG. 3 illustrates an interrupt controller for interrupt handling, according to an embodiment of the present disclosure;

FIG. 4 is a flowchart illustrating a method for handling an interrupt, according to an embodiment of the present disclosure;

FIG. 5 illustrates a post ISR scheduling latency during an interrupt, according to an embodiment of the present disclosure;

FIG. 6 is flowchart a method of reducing post ISR scheduling latency during an interrupt, according to an embodiment of the present disclosure; and

FIG. 7 illustrates a computing environment for implementing a method for handling an interrupt, according to an embodiment of the present disclosure.

### DETAILED DESCRIPTION OF DISCLOSURE

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Throughout the drawings, similar reference characters may refer to corresponding features.

Further, examples used herein are intended merely to facilitate an understanding of ways in which the embodiments herein can be practiced and to further enable those skilled in the art to practice the embodiments herein. Accordingly, the examples should not be construed as limiting the scope of the disclosure.

Herein, the term “or” refers to a non-exclusive or, unless otherwise indicated.

Unless defined otherwise, all technical terms used herein have the same meanings as commonly understood by a person having ordinary skill in the art to which this disclosure belongs.

The term “application programming interface (API) dependent” may non-exclusively refer to an ISR of an interrupt that could invoke RTOS APIs affecting a task scheduling decision of a kernel.

The term “API independent” may non-exclusively refer to an ISR of an interrupt that may not invoke RTOS APIs affecting a task scheduling decision of a kernel.

Accordingly to an embodiment of the present disclosure, a method is provided for interrupt handling, which includes receiving, at an accelerator unit, an interrupt request, stacking, by the accelerator unit, a plurality of general purpose registers in an inbuilt LIFO unit, and sending, by the accelerator unit, a vector address corresponding to the interrupt request to a processor, which processes the interrupt request.

Further, the method may include detecting, by the accelerator unit, an end of the interrupt indication, and unstacking the plurality of general purpose registers from the inbuilt LIFO unit.

For example, for a long term evolution (LTE) modem operating at a higher user equipment (UE) capability, during peak data throughput, there will be a large number of interrupts that will be processed for uplink and downlink data transmissions. The interrupt latency of each interrupt is accountable for the processor scheduling a task, which in turn affects the performance of the data processing system.

During LTE high data throughput, a protocol stack (modem) processor processes multiple interrupts every millisecond. Accordingly, the total number of interrupts processed in the complete system every millisecond will be in several thousand every second. The total Interrupt count further increases for a multi-core platform, wherein a higher number of interrupts is used by a RTOS scheduler for inter-core communication.

Unlike the conventional mechanism, a method and system in accordance with an embodiment of the present disclosure can reduce the delay involved in processing the interrupt, both by an interrupt controller and a processor. Further, unique hardware logic is provided to reduce an interrupt latency and to improve performance of the data processing system.

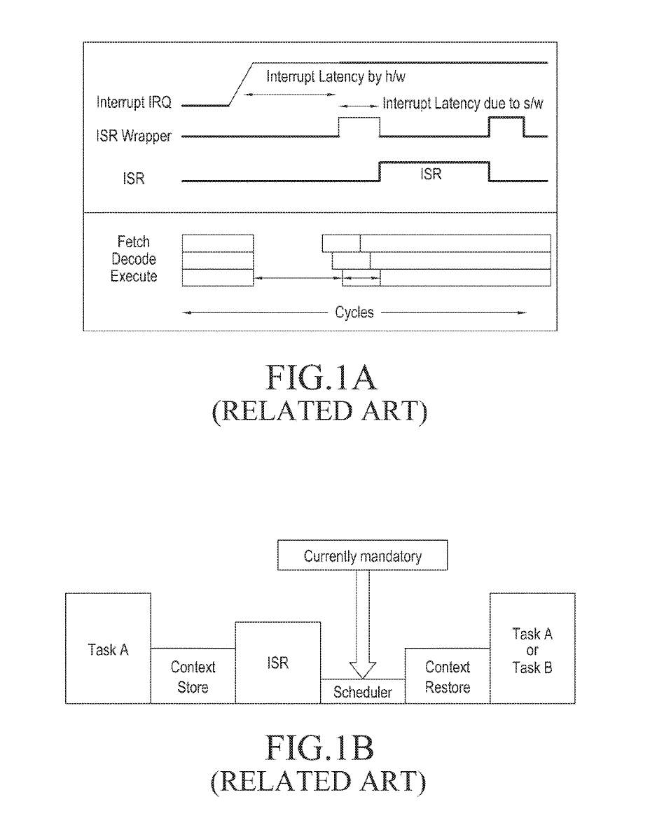

FIG. 1A illustrates a CPU cycle delay during a conventional mechanism for interrupt handling.

Referring to FIG. 1A, at first phase, interrupt latency by the hardware is incurred when an IRQ is received from one of a plurality of devices (e.g., peripheral devices) at an interrupt controller. The interrupt controller is associated with an interrupt request logic for processing the IRQ and provides a vector address corresponding to the IRQ to the CPU.

At second phase, an interrupt latency due to the CPU is incurred when the CPU accesses the vector address corresponding to the IRQ received from the interrupt controller. Further, a processor associated with the CPU invokes a corresponding ISR to stack a plurality of general purpose registers associated with the CPU, to switch a register bank, to check whether the interrupt requires ISR to be invoked, to locate or branch to a beginning of an interrupt handler, and to unstack saved registers at the end of the ISR.

Thus, the processor performs an independent operation for stacking and unstacking the CPU registers during an interrupt. Fetching, decoding, and executing pipeline activities are also reset at the IRQ, and consequently, the processor resumes by fetching an instruction from the pipeline, after hardware interrupt process. As a result of the first phase and second phase incurrence, there are significant delays in the data processing system due to the interrupt latency by the hardware and the processor, before the actual ISR is invoked.

FIG. 1B illustrates conventional post ISR scheduling latency.

Referring to FIG. 1B, after an interrupt request signal has been received at a processor, the processor abandons a current process and shifts to an ISR in order to respond the received interrupt request signal. The corresponding CPU register context is stored. After completion of ISR, the scheduler decides whether to continue with interrupted task or schedule another higher priority task.

For example, as illustrated in FIG. 1B, for a task driven (un-forced) preemption, a priority of task-A is greater than priority of task-B and a priority of task-B is greater than a priority of task-C.

At first, task-A is suspended for a message on Queue-X. While task-A is suspended, the kernel schedules task-B.

When task B is scheduled by the kernel, task-B posts a message to Queue-X. As a result, the kernel identifies that there is a higher priority task waiting on Queue-X. Thus, the kernel preempts task-B, and resumes task-A. This is a predictable preemption mode with respect to task scheduling.

As another example, for an interrupt driven (forced) preemption, where task-B is currently running, whenever there is an external interrupt signaled, the control jumps to an interrupt handler preempting task-B execution. The kernel stores preempted task-B (Task-B context in Stack). When the received interrupt signal is serviced, the kernel invokes the scheduler to identify highest priority ready task (Task-B in this case) and restores preempted task (Task-B context from Stack).

This preemption forced (or induced) because of asynchronous external factors like interrupts. Generally, after the completion of the ISR, the original operation is resumed from the point where it was preempted.

Alternatively, when the priority of task-A is greater than priority of task-B and the priority of task B is greater than the priority of task-C, at first, task-A is suspended for a message on Queue-X. While task-A is suspended, the kernel schedules task-B.

Whenever there is an external interrupt signaled, the CPU program control (e.g., referred to as a program counter of a computer processor) jumps to the interrupt handler preempting task-B execution. The kernel stores preempted task context in task-B stack.

After the signaled interrupt, the kernel sends a message to Queue-X, thereby activating task-A. Thus, the kernel invokes a scheduler to identify the highest priority ready task (task-A in this case) and re-stores the relinquished task (task-A context) from the stack.

The kernel resumes task-A from the point where it had relinquished the processor and defers execution of preempted task-B

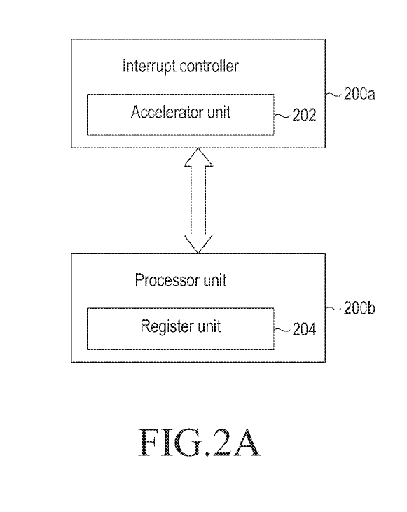

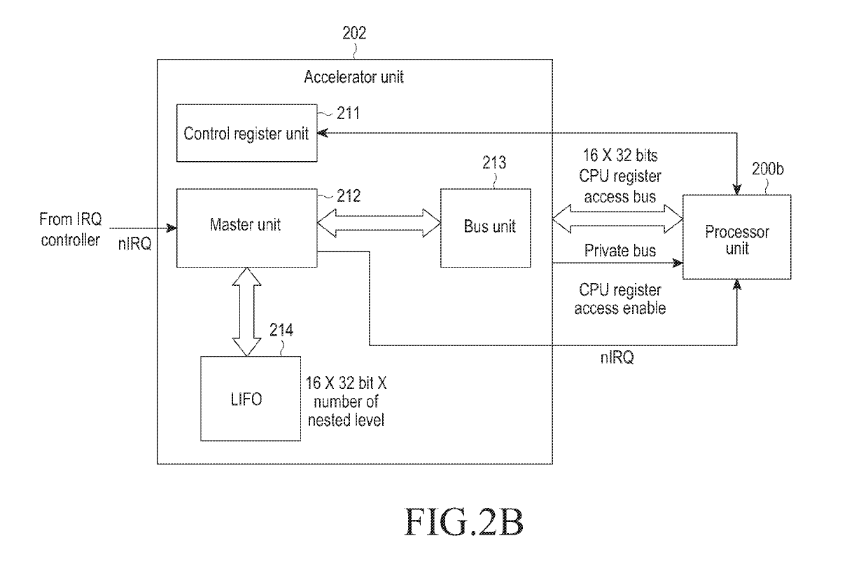

FIG. 2A illustrates an interrupt controller and a processor unit for interrupt handling, according to an embodiment of the present disclosure.

Referring to FIG. 2A, the interrupt controller 200a includes an accelerator unit 202, and the processor unit 200b includes a register unit 204. For example, the register unit 200 may include a central processing unit (CPU) register.

FIG. 2B illustrates an accelerator unit associated with an interrupt controller for interrupt handling, according to an embodiment of the present disclosure.

Referring to FIG. 2B, the accelerator unit 202 includes a control register unit 211, a master unit 212 of a bus unit 213, and an inbuilt LIFO unit 214.

Unlike the conventional mechanism illustrated in the FIG. 1A, stacking and unstacking of CPU registers may be performed at the interrupt controller 200a using only the accelerator unit 202.

Specifically, the accelerator unit 202 receives an IRQ from an interrupt request logic associated with the interrupt controller 200a. The control register unit 211 is accessed by a processor unit 200b, coupled to the interrupt controller 200a, to configure the accelerator unit 202. The CPU registers are accessed from the accelerator unit 202 through the master unit 212 associated with the bus unit 213. The bus unit 213 can read all of the CPU register values at once and store the register values into the inbuilt LIFO unit 214. The inbuilt LIFO unit 214 may be implemented using a general LIFO memory logic, The master unit 212 and the control register unit 211 may have a logical hardware that is implemented based on the functionalities discussed throughout this disclosure.

When an interrupt is received from an IRQ controller to the accelerator unit 202, the master unit 212 receives the interrupt. The master unit 212 finds the number of CPU registers to be stored in the inbuilt LIFO unit 214 by accessing control register unit 211.

The control register unit 211 is configured by the program running in the processor unit 200b during system initialization. The control register unit 211 contains the information about number of CPU registers to be stored as part of a context store operation, which depends on the RTOS used in the system. The master unit 212 performs the context store operation by accessing the CPU register values from processor unit 200b using inbuilt bus unit 213 and stores the CPU register values to the in-built LIFO unit 214. Upon completing the context store operation, the master unit 212 triggers the interrupt nIRQ to the processor unit 200b and also provides the vector address.

Upon completing the execution of ISR for the triggered interrupt, the processor unit 200b clears the interrupt vector to indicate a completion of interrupt processing. The master unit 212 receives the indication and performs context restore operation by fetching back CPU register values from the in-built LIFO unit 214 to processor unit 200b using bus unit 213 for the specified number of CPU registers configured in control register unit 211.

Further, the CPU register can be stacked in the inbuilt LIFO unit 214 while providing the vector address to the CPU. The number of register(s) pushed to the stack can be variably decided by the CPU and configured accordingly in the control register unit 211.

The processor unit 200b, associated with the CPU, can be configured to process the vector address corresponding to the IRQ received from the interrupt controller 200a.

The inbuilt LIFO unit 214, which is associated with the interrupt controller 200a, may be an inbuilt dedicated memory (e.g., a Random Access Memory (RAM).

The register unit 204 included in the processor unit 200b is used to store the registers values (i.e., CPU registers).

Although FIGS. 2A and 2B illustrate various units of the interrupt controller 200a and the accelerator unit 202, the present disclosure is not limited thereto. For example, the interrupt controller 200a and the accelerator unit 202 may include fewer or more components therein, and/or one or more of the components therein can be combined to perform the same or substantially similar functions as described above in the interrupt controller 200a and the accelerator unit 202.

Further, the labels or names of the components in FIGS. 2A and 2B are used only for illustrative purpose and do not limit the scope of the disclosure.

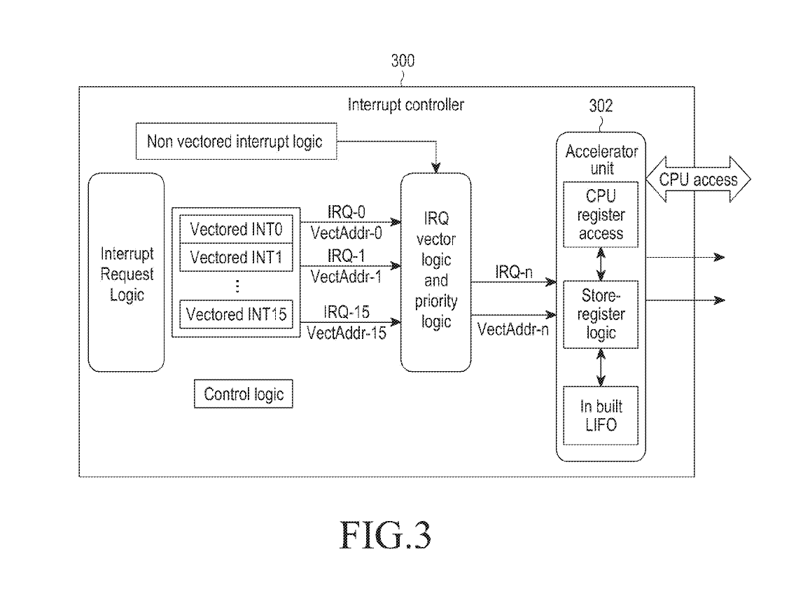

FIG. 3 illustrates an interrupt controller, according to an embodiment of the present disclosure.

Referring to FIG. 3, an IRQ-n and VectAddr-n is sent to a processor unit through an accelerator unit 302 included in the interrupt controller 300.

At this time, a bus unit associated with the accelerator unit 302 reads the CPU registers at once and stores the required number of CPU register into an inbuilt LIFO unit. For example, the stored values can be the CPU context during the interrupt.

A processor unit that processes the IRQ (included in the CPU) can therefore initiate the ISR without storing any CPU register context, which saves about 17 cycles to store all the 17 ARM® Cortex®-R4 registers (R0-R15 and CPSR (Current Program Status Register)). In general, ‘n’ cycles can be saved based on RTOS implementation, where the number of CPU registers stored can vary between R0-R(n−1) (where, n<=17).

Upon completing the ISR, the processor unit clears the interrupt, which in-turn informs the interrupt controller 300 that ISR is completed and the interrupt can be marked as inactive. During this operation the accelerator unit 302 restores the CPU registers from the inbuilt LIFO unit.

The same implementation is applicable to the interrupt controller 300 for nested interrupt and interrupt prioritization.

The memory size for an inbuilt LIFO unit can be selected based on a memory required to store a worst case number of CPU registers and depth of nested interrupt supported.

For example, Tables 1 and 2 illustrate profiling results of an RTOS following cycle consumption using a hardware platform based on the ARM® Cortex®-R4 with a vector interrupt controller.

TABLE 1

| | Interrupt—Context store | | |
|---|---|---|---|
| | | | Interrupt to |
| | IDLE to | Task to | Interrupt |
| | Interrupt | Interrupt | (Nested) |
| cycles | 40 | 89 | 71 |

TABLE 2

| | Interrupt—Context restore | | |
|---|---|---|---|
| | | | Interrupt to |
| | IDLE to | Interrupt | Interrupt |
| | Interrupt | to Task | (Nested) |
| cycles | 95 | 95 | 31 |

### Profiled when Code in TCM

As shown above, there is a 10 to 26 cycle reduction in the above data, if the CPU register context store and restore occurs using an accelerator unit, as described above, (i.e., a flat 26 cycle reduction for RTOS storing R0 to R12 and 10 cycles for certain RTOS storing only R0-R5).

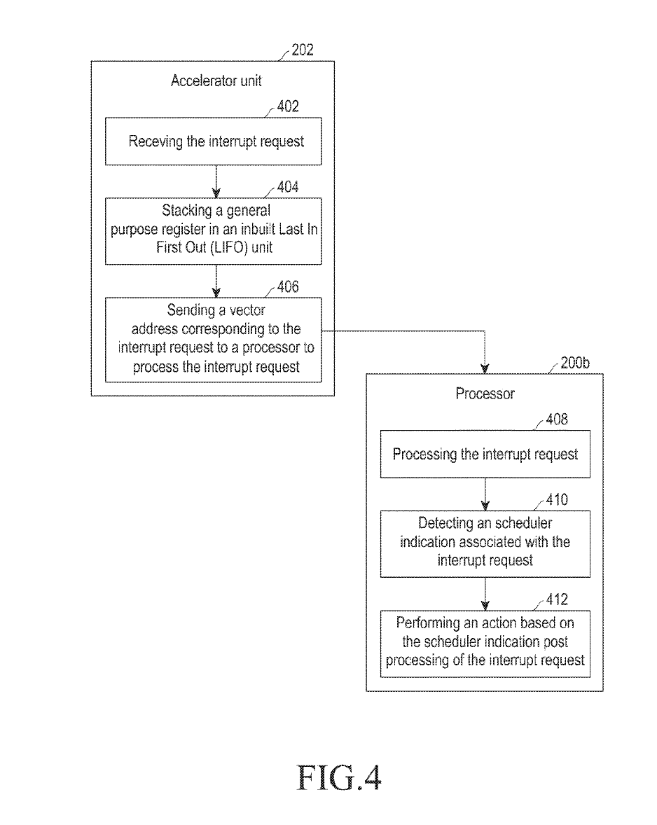

FIG. 4 is a flow chart illustrating a method for handling an interrupt, according to an embodiment of the present disclosure. For example, the method of FIG. 4 will be described as being performed by the accelerator unit 202 and the processor 200b as illustrated in FIG. 2A.

Referring to FIG. 4, in step 402, the accelerator unit 202 receives an IRQ.

In step 404, the accelerator unit 202 stacks a plurality of general purpose registers in an inbuilt LIFO unit.

In step 406, the accelerator unit 202 sends the vector address corresponding to the IRQ to the processor unit 200b to process the IRQ received.

In step 408, the processor unit 200b processes the IRQ received from the accelerator unit 202.

In step 410, the processor unit 200b detects a scheduler indication associated with the IRQ.

In step 412, the processor unit 200b performs an action based on the scheduler indication post processing of the IRQ.

For example, a VIC associated with the accelerator unit 202 receives the interrupt. The VIC processes the received interrupt and provides the vector address based on the priority of the interrupt to the CPU.

Unlike the conventional mechanism, the method illustrated in FIG. 4 allows the vector address corresponding to the interrupt and the CPU register from the VIC register unit to communicate with the CPU through the accelerator unit 202 (VIC Extension (Extn)). Further, a bus unit associated with the accelerator unit 202 may read all of CPU registers at once and store the CPU registers in a LIFO unit associated with the accelerator unit 202.

Furthermore, the accelerator unit 202 communicates with the processor unit 200b associated with the CPU. The processor unit 200b therefore executes the ISR and provides an end of interrupt indication to the accelerator unit 202. The processor unit 200b restores the CPU registers from the inbuilt LIFO unit, updating the status of the interrupt (mark as inactive).

The various actions, acts, blocks, steps, etc., as illustrated in FIG. 4, may be performed in the order presented, in a different order, or simultaneously. Further, in some embodiments, some of the actions, acts, blocks, steps, etc., may be omitted, added, modified, skipped, etc., without departing from the scope of the disclosure.

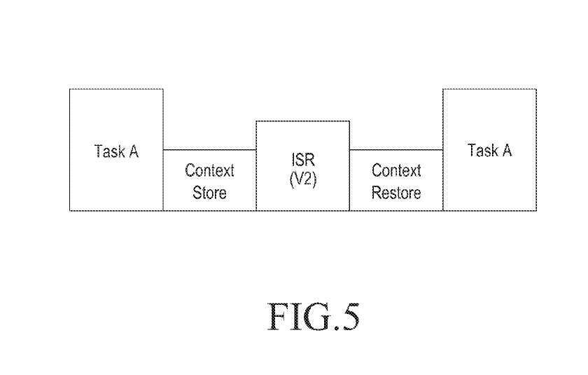

FIG. 5 illustrates post ISR scheduling latency during an interrupt, according to an embodiment of the present disclosure. Unlike the conventional mechanism illustrated in FIG. 1B, in FIG. 5, the ISR does not invoke any APIs that can alter scheduling decisions, thereby reducing delay by omitting the scheduler operation.

For example, the proposed mechanism can be broadly classified as API Independent, which does not invoke any RTOS API that would impact a scheduling decision, or API dependent, which invokes RTOS API that might impact a post interrupt scheduling decision.

Because the particular classification is known at the beginning of the interrupt processing through the accelerator unit 202 and the interrupt controller 200a, the scheduler at the end of interrupt processing can be avoided, and the amount of time spent in context store and context restore operations is reduced.

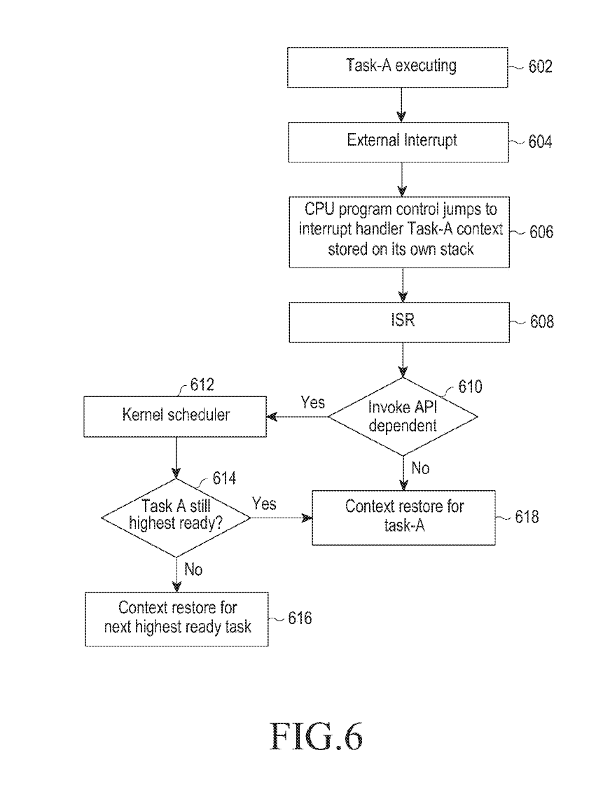

FIG. 6 is a flowchart illustrating a method for reducing post ISR scheduling latency, according to an embodiment of the present disclosure. For example, the method of FIG. 6 will be described as being performed by the accelerator unit 202 and the processor 200b as illustrated in FIG. 2A.

Referring to FIG. 6, in step 602, task—A is executed at the processor unit 200b.

In step 604, the processor unit 200b receives an external interrupt. Each interrupt may be associated with a ‘Sticky-bit’ that categorizes the associated ISR as being API dependent or API independent. A user (e.g., a programmer), at the time of defining or registering the ISR, configures the sticky bit, which could be stored in a global Interrupt table.

In step 606, at the accelerator unit 202, a CPU program controls jumping to the interrupt handler by preempting task-A execution and the kernel stores preempted task context in task-A stack.

In step 608, the processor unit 200b receives an external interrupt for the ISR, from the interrupt handler associated with the accelerator unit 202.

In step 610, the processor unit 200b determines whether to invoke an API dependent configuration.

If processor unit 200b determines that the API dependent configuration is to be invoked, the processor unit 200b invokes a kernel scheduler, based on the information available in a global interrupt table.

In step 614, the kernel scheduler determines whether the task-A still has the highest priority ready.

In step 616, the processor unit 200b restores the context for next highest priority ready task. If the task-A still has the highest priority ready in the step 614 (or the API dependent configuration is not to be invoked in step 610), the processor unit 200b performs a context restore for task-A in step 618.

For example, one of the possible approaches to implement in the current ARM® based platform is by mapping all API dependent ISRs to the nIRQ all the API independent ISRs to nFIQ, and perform only minimal context store (e.g., SRS instruction, save CPSR (Current Program Status Register) & LR (Link Register) in task stack) for API independent ISRs as shown.

The nIRQ is the interrupt vector number. ‘n’ stands for interrupt number which ranges from values 1 to total number of interrupts supported in the system.

The nIRQ is generic ARM literature terminology to denote interrupt number n. The “n” in the “nFIQ” stands for fast interrupt occurred number which ranges from values 1 to Total number of fast interrupts supported in the system. nFIQ is generic ARM literature terminology to denote fast interrupt number n.

Nesting interrupt support can also be performed, where in post first invocation of the API dependent ISR, all further ISRs (i.e., API dependent and API independent) can be treated as API dependent ISRs.

For example, Table 3 below shows the latency reduction during post ISR activities.

TABLE 3

| | Post ISR activities | | |
|---|---|---|---|
| | Scheduler | Context Restore | Total |
| cycles | 37 | 54 | 71 |

As shown in the Table 3, there is a flat reduction of 37 cycles incurred in scheduler activities, which is an approximate 40% reduction of post ISR scheduling latency.

Although the method and the accelerator unit 202 described in the aforementioned embodiments is for interrupt handling, it is to be understood that other embodiments are not limited thereon. A person having ordinary skill in the art may identify that proposed method or accelerator unit 202 can be used to perform various operations in process, a thread component, a task, a job, etc., thereby decreasing the number of CPU cycles as compared with the conventional mechanisms.

For example, in the conventional systems, when a user generated instruction requires information to be read from a register, the CPU uses PUSH and POP operations to read the information from the register. The CPU allocates a separate CPU cycle for each of such PUSH/POP operations.

Unlike the conventional mechanisms, the proposed accelerator unit 202 provides an option to trigger hardware assisted PUSH and POP operation within a single CPU cycle.

Specifically, the CPU instructs the accelerator unit 202 to read the information from the register. The accelerator unit 202 uses a bus unit to read all of the registers at once via PUSH and POP operations within a single CPU cycle, thereby reducing the delay involved in the CPU instruction cycle.

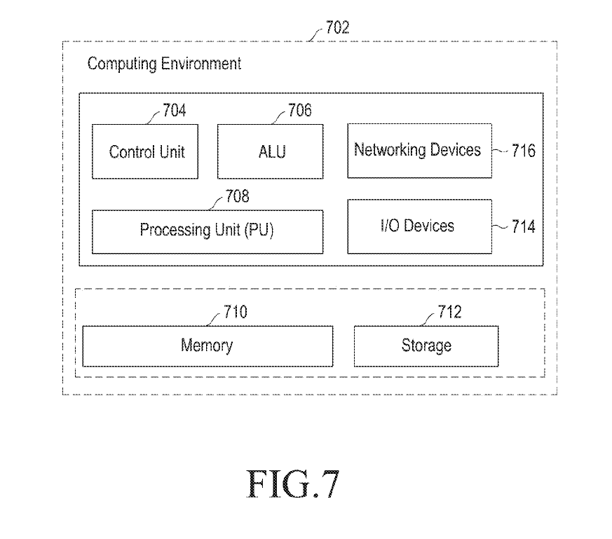

FIG. 7 illustrates a computing environment for implementing a method for interrupt handling, according to an embodiment of the present disclosure.

Referring to FIG. 7, the computing environment 702 includes a processing unit 708, a control unit 704, an arithmetic logic unit (ALU) 706, a memory 710, a storage unit 712, a plurality of networking devices 716, and a plurality Input output (I/O) devices 714. The processing unit 708 is responsible for processing the instructions of a scheme. The processing unit 708 receives commands from the control unit 704 in order to perform its processing. Further, any logical and arithmetic operations involved in the execution of the instructions are computed using the ALU 706.

The storage unit 712 may include one or more computer-readable storage media. The storage unit 712 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage unit 712 may, in some embodiments, be considered a non-transitory storage medium. The term “non-transitory” may indicate that the storage medium is not embodied in a carrier wave or a propagated signal. However, the term “non-transitory” should not be interpreted to mean that the storage unit 712 is non-movable. The storage unit 712 may be configured to store larger amounts of information than the memory 710. For example, a non-transitory storage medium may store data that can, over time, change (e.g., in Random Access Memory (RAM) or cache).

The overall computing environment 702 can be composed of multiple homogeneous and/or heterogeneous cores, multiple CPUs of different kinds, special media and other accelerators.

The processing unit 708 is responsible for processing the instructions of the technique. Further, the plurality of processing units 708 may be located on a single chip or over multiple chips.

The technique comprising of instructions and codes required for the implementation are stored in the memory unit 710 and/or the storage 712.

At the time of execution, the instructions may be fetched from the corresponding memory 710 and/or storage 712, and executed by the processing unit 708.

In case of any hardware implementations various networking devices 716 or external I/O devices 714 may be connected to the computing environment to support the implementation through the networking unit and the I/O device unit.

The networking device 716 may be used to perform the instructions received from an accelerator unit. The networking device 716 may be used to communicate interrupt signals associated with the IRQ with the various units of an interrupter controller and further with the various units of the CPU.

The embodiments disclosed herein can be implemented through at least one software program running on at least one hardware device and performing network management functions to control the elements. The elements illustrated in FIGS. 1 to 7 include blocks that can be at least one of a hardware device, or a combination of hardware device and software module.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method for interrupt handling, the method comprising:
receiving, by an accelerator unit, an interrupt request;
stacking, by the accelerator unit, a plurality of general purpose registers in an inbuilt last in first out (LIFO) unit; and
sending, by the accelerator unit, a vector address corresponding to the interrupt request to a processor, which processes the interrupt request.

2. The method of claim 1, wherein the plurality of general purpose registers are read at once by the accelerator unit using a bus unit.

3. The method of claim 1, further comprising:
detecting, by the accelerator unit, an end of interrupt indication; and
unstacking, by the accelerator unit, the plurality of general purpose registers from the inbuilt LIFO unit, in response to the end of interrupt indication.

4. The method of claim 1, wherein a scheduler indication associated with the interrupt request is detected and an action is performed based on the scheduler indication.

5. The method of claim 4, wherein the scheduler indication indicates that an interrupt service routine (ISR) of the interrupt request is application programming interface (API) dependent when the ISR invokes a real-time operating system API.

6. The method of claim 4, wherein the scheduler indication that an interrupt service routine (ISR) of the interrupt request is application programming interface (API) independent when the ISR does not invoke a real-time operating system API.

7. The method of claim 4, wherein the scheduler indication is configurable, and
wherein the scheduler indication indicates whether an interrupt service routine (ISR) corresponding to the interrupt request is application programming interface (API) dependent or API independent.

8. A method for handling an interrupt, the method comprising:
receiving, by a processor from an accelerator unit, an interrupt request;
processing, by the processor, the interrupt request;
detecting, by the processor, a scheduler indication associated with the interrupt request; and
performing, by the processor, an action based on the scheduler indication.

9. The method of claim 8, wherein the action includes one of:
invoking a task scheduler when the scheduler indication indicates that an interrupt service routine (ISR) of the interrupt request is application programming interface (API) dependent; and
sending an end of interrupt indication to the accelerator unit when the scheduler indication indicates that the ISR of the interrupt request is API independent.

10. The method of claim 9, wherein the scheduler indication indicates that the ISR of the interrupt request is API dependent.

11. The method of claim 9, wherein the scheduler indication indicates that the ISR of the interrupt request is API independent.

12. The method of claim 8, wherein the scheduler indication is configurable, and
wherein the scheduler indication indicates whether an interrupt service routine (ISR) corresponding to the interrupt request is application programming interface (API) dependent or API independent.

13. An interrupt controller, comprising:
a processor; and
an accelerator unit including an inbuilt last in first out (LIFO) unit, wherein the accelerator unit is configured to:
receive an interrupt request,
stack a plurality of general purpose registers in the inbuilt LIFO unit, and
send a vector address corresponding to the interrupt request to the processor, which processes the interrupt request.

14. The interrupt controller of claim 13, wherein the processor is further configured to:
receive the interrupt request from the accelerator unit;
process the interrupt request;
detect a scheduler indication associated with the interrupt request; and
perform an action based on the scheduler indication.

15. The interrupt controller of claim 14, wherein the action comprises one of:
invoking a task scheduler when the scheduler indication indicates that an interrupt service routine (ISR) of the interrupt request is application programming interface (API) dependent; and
sending an end of interrupt indication to the accelerator unit when the scheduler indicates that the ISR of the interrupt request is API independent.

16. The interrupt controller of claim 15, wherein the scheduler indication indicates that the ISR of the interrupt request is API dependent.

17. The interrupt controller of claim 15, wherein the scheduler indication indicates that the ISR of the interrupt request is API independent.

18. The interrupt controller of claim 13, wherein the scheduler indication is configurable, and
wherein the scheduler indication indicates whether an interrupt service routine (ISR) corresponding to the interrupt request is application programming interface (API) dependent or API independent.
